(19) United States
(12) Patent Application Publication
(10) Pub. No.: US 2004/0023034 A1
(43) Pub. Date: Feb. 5, 2004

(54) Eelctrically switchable multilayer films with rheologically controllable suspensions

(76) Inventors: Friedrich Georg Schmidt, Haltern (DE); Andreas Pawlik, Recklinghausen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/258,605

(22) PCT Filed: Mar. 21, 2001
(86) PCT No.: PCT/EP01/03218

(30) Foreign Application Priority Data
May 5, 2000 (DE) 100 21 984.5

(51) Int. Cl. B32B 9/04

(52) U.S. Cl. 428/411.1; 428/425.8

(57) ABSTRACT

A multilayer film having electrically switchable optical properties, containing a suspension of electrophoretically mobile particles located between two electrodes, where the suspension exhibits a negative electrorheological effect.

The multilayer films can be used for the production of flat-panel screens, watches, display panels or computers.

The invention relates to multilayer films using electrophoretically mobile particles in a rheologically controllable suspension.

In order to change the color and transparency of large areas, various methods are known, such as, for example, thermochromicity or LCDs. A similar technological background is possessed by information systems, such as, for example, information signs, advertising boards, price indicators, timetable displays, computer displays or flat-panel screens in general. The information displayed may be fixed, for example in the case of advertising billboards, or electronically changeable, for example in computer displays.

This information system uses LED or LCD methods, for example, in the computer display area or conventional cathode ray tubes.

A novel development for display of electronically changeable information is the “electronic ink” of Prof. J. Jacobson et al. This technique utilizes the alignment of single- or multicolored pigment particles in an electric field in order to display image information. Details can be obtained, for example, in J. Jacobson et al, IBM System Journal 36, (1997), pages 457-463, or B. Comiskey et al., Nature, Vol. 394, July 1998, pages 253-255.

For the production of corresponding bipolar, single- or two-colored particles in various embodiments and their use in electrophoretic displays, reference may be made, for example, to WO 98/03896. It is described here how these particles are suspended in an inert liquid and encapsulated in small bubbles of a support material. This technique allows macroscopic display of two colors, for example by rotation of a two-colored particle, depending on the applied electric field.

WO 98/19208 describes a similar electrophoretic display in which electrophoretically mobile particles can be moved in an optionally colored liquid within a microcapsule by means of an electric field. Depending on the field direction, the particles align with one electrode and so display yes/no color information macroscopically (either the color of the particles or the color of the liquid is visible).

WO 98/41899 discloses electrophoretic displays which, although based on the above-described principles, contain either fluorescent or reflective particles. In addition, the use of a suspension having liquid-crystalline behavior is also described. The liquid crystals block or facilitate electrophoretic migration of the particles, depending on the applied electric field.

WO 98/41898 likewise describes an electrophoretic display system of this type which, due to its special arrangement, can be produced by a printing process, in particular by ink-jet printing. Advantageously, both electrodes and also the electrophoretic display itself can be produced in successive printing steps.

It is a common feature of these methods that the suspension liquid and the particles are embedded in capsules, bubbles or other cavities of a polymeric material. The particles can also be encapsulated with the suspension liquid; these capsules can then either be introduced in prefabricated form into the polymerization process for the support material or formed together with the support material in a complex emulsion polymerization.

WO 99/56171 describes a “shutter mode” display based on the electrophoretic migration of particles in a suspension. In order to obtain better contrast from the “on” to the “off” state of the display, the cavities here have a conical design. The conical structure enables the combination of the particles at the smallest point of the cavity, so that light can in this case exit from the cavity virtually unhindered. The observer perceives only a small area as a flaw. The mode of operation of the displays consisting of conical cavities corresponds to the electrophoretic displays known from the abovementioned literature.

These displays have the disadvantage that, without an external electric field, the particles rapidly convert back into an ordered state distributed over the entire cell. This is also favored by heat or external vibrations, and consequently the displayed information fades again with time if an electric field does not permanently maintain the desired ordered state of the particles.

The object of the present invention was therefore to develop multilayer films which work with electrophoretically mobile particles and whose switching states are retained over a long period even without an external electric field.

Surprisingly, it has been found that rheologically controllable suspensions containing electrophoretically mobile particles are suitable for the display of switching states which are retained over an extended period even without an external electric field.

The present invention therefore relates to a multilayer film having electrically switchable optical properties which contains a suspension of electrophoretically mobile particles located between two electrodes, where the suspension exhibits a negative electrorheological effect.

With the aid of the suspension having a negative electrorheological effect, bistable multilayer films are obtained. On application of an electric field, the electrophoretically mobile particles align in the field in accordance with their charge, i.e. the external observer perceives either the color of the particles or that of the suspension liquid. The particles can move unhindered in the suspension when an electric field is applied. If the electric field is removed, the viscosity of the electrorheological suspension increases considerably, and the particles are substantially fixed in the ordered state they have just assumed. The displayed information is correspondingly likewise fixed, and therefore remains visible in a stable manner, even without an external electric field.

The multilayer films according to the invention may be very thin (from 2 to 5 mm) and are therefore particularly suitable for three-dimensionally shaped objects, such as, for example, the inside of windscreens.

The multilayer films of the invention contain the requisite technical devices for the display of color information. The electrophoretically mobile particles in a rheologically controllable suspension are embedded in a suitable matrix or support layer—optionally in corresponding cavities or compartments. This support layer is in turn arranged between the control electrodes.

In order to obtain suspensions having a negative electrorheological effect which are employed in the invention, the suspension can either contain a dissolved substance or electrophoretically mobile particles which exhibit the negative electrorheological effect.

It is possible for the suspension to contain a plurality of particle types, at least one of which exhibits a negative electrorheological effect.

Suspensions of liquids which change their viscosity in the presence or absence of an electric field (electrorheological effect, ER) are known. A distinction is made in the literature between positive and negative ER, the viscosity increasing with increasing electric field strength in the case of positive ER and dropping in the case of negative ER. The causes of positive and negative ER are not yet fully known (for example T. Uemura et al., Polym. Prep. ACS, Div. Polym. Chem., 1994, 35(2), 360-361; K. Minagawa et al., Journal of Intelligent Material Systems and Structures, Vol. 9 August 1998, 626-631; H. C. Conrad et al., J. Rheol. 41(2) 1997, 267-281; O. Quadrat et al., Langmuir 2000, 16, 1447-1449; C. Zukowski IV et al., J. Chem. Soc., Faraday Trans. I, 1989, 85(9), 2785-2795; T. Hao et al,. Langmuir 1999, 15, 918-921); however, they are attributed to a re-ordering of molecules on the basis of van der Waal's interactions, which are overcome on application of an electric field.

Compounds which are suitable for a negative electrorheological effect by a substance dissolved in a suspension liquid are, for example, polycondensates made from phenyl isocyanate and polytetramethylene glycol or p-chlorophenyl isocyanate and polytetramethylene glycol or polymethyl methacrylate hydrated as alkali metal salt or as a blend with polystyrene-block-(polyethylene-co-propylene).

For the present invention, only the negative electrorheological effect of the suspension is of importance. Substances, liquids or suspensions are known which, besides a rheological effect, i.e. a viscosity-modifying effect, exhibit a liquid-crystalline effect (LCD) on application of an electric field.

This additional LCD effect, which has an adverse effect on the optical properties of the suspension or multilayer film, has nothing in common with the negative electrorheological effect of the suspension and is not desired here.

An LCD effect of this type is an electrorheological effect which can occur in suspensions of immiscible liquid-crystalline substances, as described, for example, by Tajiri (Tajiri et al., J. Rheol., 41(2), 335 (1997)). Mixtures of ambient (suspension) matrix and liquid-crystalline substances result in phase-separated morphologies, in which the liquid-crystalline phase forms a higher aspect ratio (length/diameter) in the field direction if an electric field is applied. Phase separation of the liquid-crystalline substances can result in an undesired modification of the optical properties of the suspension.

The literature describes systems of liquid, inhomogeneous blends which are not based on liquid-crystalline substances, but instead have a higher dielectric constant (for example Kimura et al., J. Non-Newtonian Fluid Mech. 76 (1998) 199-211), where the optical properties and the dielectric constant, as is known to the person skilled in the art, can be modified.

In the present invention, therefore, only suspensions having a negative electrorheological effect which exhibit only slight or no optical modifications in an applied electric field can be employed.

In order to obtain the suspensions having a negative electrorheological effect which are employed in the invention, the suspension can either contain a dissolved substance or electrophoretically mobile particles which exhibit the negative electrorheological effect.

The substances dissolved in the suspension are generally of a polymeric nature and are therefore only soluble in the suspension liquid up to a certain molecular weight. Which substance is sufficiently soluble in which liquid can be determined fairly easily by preliminary experiments.

It is likewise possible to employ the abovementioned substances in particle form, i.e. as particles which are not electrophoretically mobile, as electrorheological control agent (RCA).

Furthermore, the electrophoretically mobile particles can exhibit the necessary negative electrorheological effect themselves. This can take place, for example, by coating electrophoretically mobile particles with polycondensates made from phenyl isocyanate and polytetramethylene glycol or p-chlorophenyl isocyanate and polytetramethylene glycol or polymethyl methacrylate hydrated as alkali metal salt or as a blend with polystyrene-block-(polyethylene-co-propylene).

In addition to the coating with RCA substances, the particles may additionally have a coating of polyacrylates, polymethacrylates, polyurethanes or polyamides, either above or advantageously below the RCA substance.

The electrophoretically mobile particles themselves may contain inorganic or organic pigments, such as, for example, TiO₂, Al₂O₃, ZrO₂, FeO, Fe₂O₃, carbon black, fluorescent pigments, phthalocyanines, porphyrins or azo dyes. Such particles can in turn have a coating of polyacrylates, polymethacrylates, polyurethanes or polyamides.

The suspensions may be contained in compartments of the multilayer film, whose size is dependent on the requisite mechanical stability and optical resolution of the switching states. If, for example, an indicator board is to display information, the compartments must be smaller than in the case of a color change of, for example, an automobile sunroof.

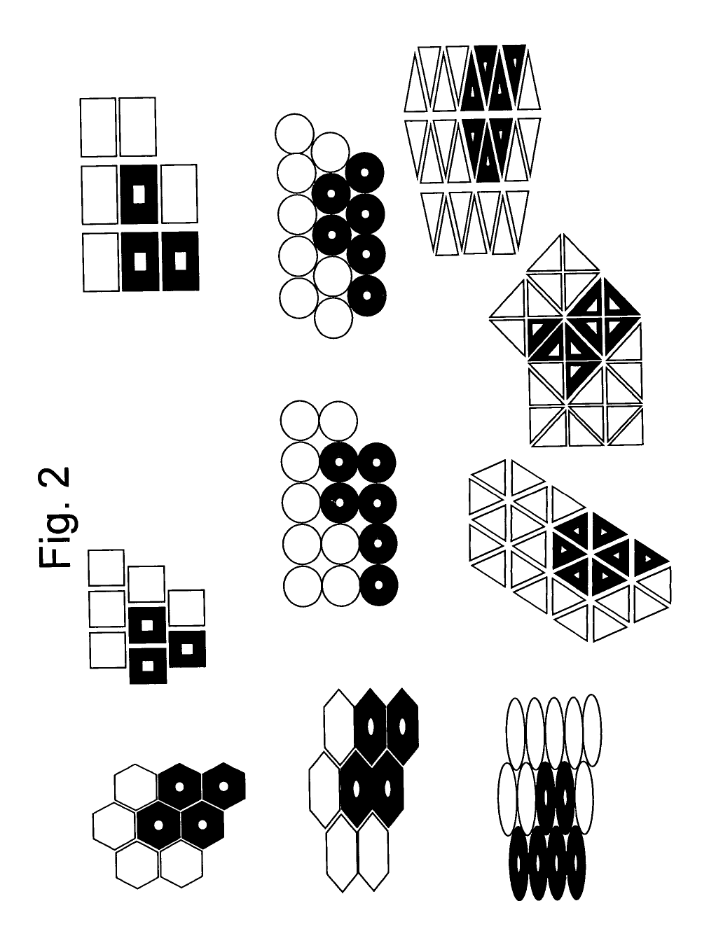

The compartments containing the suspension can have a monomodal, unimodal, bimodal or multimodal size distribution. The compartments having this size distribution can in turn in each case be arranged regularly or stochastically in the multilayer film. FIG. 2 shows a selection of regular arrangements of unimodal compartments.

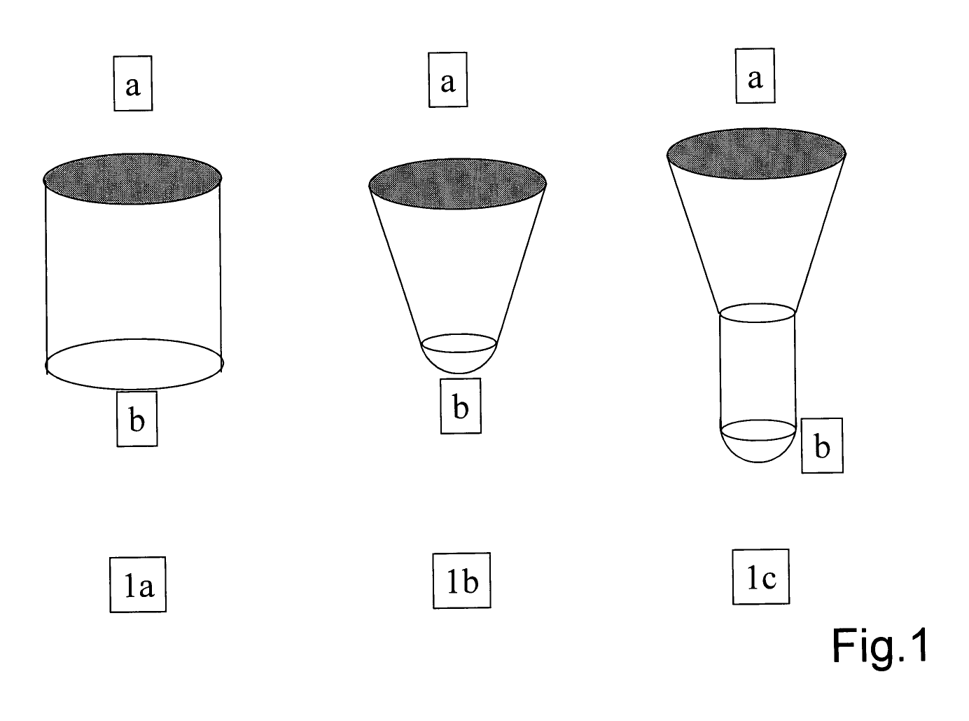

In a preferred embodiment of the present invention, the compartments have a larger visible surface than the base surface. FIGS. 1 b and 1 c show diagrammatic side views of such compartments.

The compartments, microcompartments or cavities (used synonymously below) of the multilayer film according to the invention can be introduced into a support material or into a film, for example by sewing, embossing, 3D printing, erosion, etching, casting with casting compositions, injection molding, photographic or photolithographic processes or interference methods. The production of microstructured surfaces of this type is described, for example, in DE 29 29 313, WO 97/06468, U.S. Pat. No. 4,512,848, DE 41 35 676, WO 97/13633 or EP 0 580 052. Further methods for the production of small structures are described by Younan Xia and George M. Whitesides in Angew. Chem. 1998, 110 568-594. These methods, known as “soft lithography”, enable the production of very small structures in the range from below 1 μm to about 35 nm. A further method is micromilling of a master, with which sheets or films having the desired microstructure can be produced. The master represents a negative mold. Casts can then be taken from this in an embossing, casting or injection molding process.

Alternatively, an unstructured film can also be provided with cavities of the desired dimensions and shapes. Erosive or cutting methods, such as laser radiation or drilling/milling, for example using a CNC machine, are likewise appropriate here.

The support material of the cavities, i.e. the multilayer film or a part of this film, may be optically transparent, colorless or colored. The control electrodes are in each case attached to the support above and below the cavities, where the electrode arranged above the cavities, i.e. between the observer and the cavities, may of course be just as transparent or colored as the support material. The control electrode attached below the cavities is, in order to keep the electrode voltages low, usually attached between the illumination unit and the cavities and should then be transparent.

If the support material, suspension liquid and electrodes are transparent, the multilayer film according to the invention can be switched between at least two different optically transparent states. In the ideal case, this means switching of the multilayer film between “optically transparent” and “optically non-transparent”.

Optical transparency and non-transparency represent the extreme switching states. In practice, substantial transparency/non-transparency is sufficient, for example for darkening or dimming of windows.

Suitable support materials for the cavities are all mechanically or lithographically workable polymers, such as, for example, thermoplastics, polycarbonates, polyurethanes, polysiloxanes, polyolefins, such as, for example, polyethylene, polypropylene, COC (cycloolefinic copolymers), polystyrene, or ABS polymers, PMMA, PVC, polyesters, polyamides, thermoplastic elastomers or crosslinking materials, such as UV-curing acrylate coatings, but also polytetrafluoroethylene, polyvinylidene fluoride or polymers of perfluoroalkoxy compounds, whether as homopolymer or copolymer or as a mixture constituent of a polymer blend.

The cavities can have any desired shape. The cavities advantageously have a round, oval, triangular, rectangular, square, hexagonal or octagonal surface on the side facing the observer's eye (visible surface). Examples are shown in FIG. 2.

The visible surface of the compartments should be greater than 10,000 μm², preferably greater than 40,000 μm², particularly preferably greater than 62,500 μm² and very particularly preferably greater than 250,000 μm². It is also possible for the visible surface of the compartments to be larger than the base surface. A ratio of from 1:10 to 1:1.5 is appropriate here.

The depth of the compartments can be from 20 to 250 μm, preferably from 30 to 200 μm, very particularly preferably from 50 to 100 μm, independently of the visible surface.

The land widths between the individual compartments on the upper side of the multilayer film should be kept as small as possible; lands having a width of 2-50 μm, particularly preferably 5-25 μm, are preferred. The land upper sides of the compartments can have an opaque coating or be mirrored. Thus, for example, an aluminum lamination, metal vapor deposition or TiO₂ coating can be carried out. This prevents undesired exit of light at the lands if the light exit via the compartments is blocked by the electrophoretically mobile particles.

After the support layer has been provided with the desired cavities or compartments, the cavities are filled with the electrophoretically mobile particles and the suspension liquid. This can be carried out, for example, by introducing the suspension and wiping off the excess, by direct knife coating/spreading of the suspension, by ink-jet methods in a printing operation or by self-filling by means of capillary forces. By means of these measures, particle suspensions are introduced directly into the compartments. The compartments must subsequently be encapsulated or sealed. The filling can also be carried out by means of capillary forces via fine channels, in which case the cavities are sealed before the filling operation. This is advantageously carried out using a cover film which is bonded tightly to the microcompartment film or to the lands of the compartments. Diverse methods can be used for sealing the cavities, such as, for example:

adhesive bonding or thermal melting (microwave warming, contact or friction welding, hot-melt adhesive, or lamination)

reactive resins, in particular UV-curing (for example acrylate dispersions) or 2-component systems (for example polyurethane coating systems) which are immiscible with the pigment suspension,

interfacial polymerization, interfacial polycondensation and other methods which are also used, for example, in the area of microencapsulation technologies, as described, for example, in “Microencapsulation: methods and industrial applications”, Ed. S. Benita, Marcel Dekker Inc., NY, 1996, for the encapsulation of spherical particles.

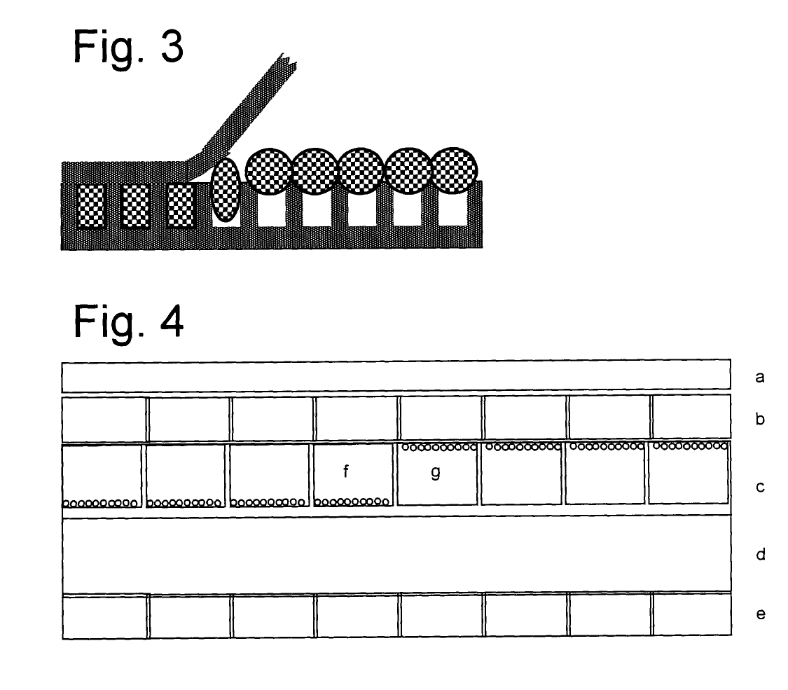

It is also possible to employ pre-encapsulated suspensions of electrophoretically mobile particles, i.e. prepared capsules. These prepared capsules can, as shown in FIG. 3, be pressed or forced into the compartments of the multilayer film. The compartments filled in this way must subsequently be sealed again using a cover film. This technique significantly reduces the stability requirements of the capsule wall material for practical use given an appropriately matched ratio between capsule size and compartment size, since the capsules are surrounded by the lands of the multilayer film. Furthermore, the arrangement of the capsules in the prepared compartments forces a regular arrangement of the capsules.

It is important in both variants that if at all possible no air or other gas inclusions take place during the sealing, no reactions occur between the suspension medium or the microparticles of the suspension and the capsule layer, and that no leaks to the environment or connections between the individual compartments exist.

The compartments or prepared capsules can be filled with one suspension or with a plurality of suspensions, for example suspensions having a color change on reversal of the applied electric field.

It is furthermore possible to omit coloring by the suspension, i.e. to fill the compartments with an optically transparent and colorless suspension liquid in addition to the particles. Suitable optically transparent and colorless liquids are, for example, nonpolar organic liquids, such as paraffin or isoparaffin oils, or low-molecular-weight or low-viscosity silicone oils.

The suspension liquids may furthermore be optically transparent and colored. For the production of multicolored multilayer films, for example for displays, each three adjacent compartments can contain differently colored (for example red, yellow and blue) suspension liquids.

Colored suspensions must have a light-fast color and must not undergo any reactions with the material of the multilayer film or of the cover layer. They may furthermore contain fluorescent or phosphorescent substances. The use of fluorescent or phosphorescent substances facilitates a higher light yield and/or use of light sources having a UV radiation component. Examples of suitable fluorescent dyes are Cumarin 314T from Acros Organics or Pyromethene 580.

The production of electrophoretically mobile particles having a diameter of from 0.1 to 20 μm, preferably from 0.3 to 10 μm, particularly preferably from 0.4 to 5 μm, can be carried out in accordance with WO 98/41898, WO 98/41899 or WO 98/0396. This includes the coating of the pigments with organic and/or polymeric materials and/or use of the pure pigments which have been provided with electric charges, for example by treatment of charge-controlling additives (see, in particular, WO 98/41899).

The particles must be freely mobile in the suspension liquid so that the particles, owing to their charge, can move to one of the electrodes, depending on the applied electric field. The “off”/“on” state of a compartment or the macroscopically perceptible color or transparency is therefore determined by the spatial arrangement of the particles and can be controlled by the electric field.

FIG. 4 shows an illustrative structure of a multilayer film according to the invention, where

a) denotes the cover layer

b) denotes the front electrode

c) denotes the support material of the compartments

d) denotes the illumination unit, and

e) denotes the counterelectrode.

The cover layer a) and the front electrode b) may be identical, and the arrangement of the illumination unit d) and the counterelectrode e) may also be reversed.

If the particles are localized by the electric field on the side of the compartment facing away from the observer (base surface, “b” in FIGS. 1 a, b, c), the particles are invisible or only slightly visible to the observer, and the light from the illumination unit can pass through the suspension liquid and the support material virtually unhindered (cavity f in FIG. 4). In cavity g in FIG. 4, the particles are localized on the side of the cavity facing toward the observer and thus screens out the light from the illumination unit. A dark area results, with the light only being able to exit through the lands of the support material. The lands of the film should therefore be designed as thinly as possible and/or have a light-opaque coating.

Addressing the compartments or particles requires two electrodes (b and e in FIG. 4), of which at least the electrode of the base surface (e in FIG. 4) should be substantially transparent to the light from the illumination layer.

The addressing of the electrodes, i.e. in the extreme case the addressing of individual compartments, can be carried out, for example, by a row/column arrangement of switch units as described in WO 97/04398. If the compartments are too small for individual addressing, a plurality of compartments are switched by each switch unit.

The optional illumination unit (d in FIG. 4) should facilitate uniform illumination of the multilayer film, but should nevertheless be flat. The use of light sources installed at the side, whose light is distributed over the entire field of view by a light guide plate, is appropriate here. Plastic plates with a strong light-scattering action are disclosed, for example, in EP 0 645 420. These plates are constructed in such a way that total internal reflection of the incident light is prevented and instead diffraction of the light from the plate or, in the present invention, from the multilayer film is facilitated. Further illustrative embodiments of light guide plates are given in EP 0 645 420 and EP 0 590 471. These illumination systems are employed, for example, for back-lit information signs.

Suitable light guide plates or diffuser plates contain particles which are colorless, but have different light refraction, in a colorless matrix material. The propagation direction of light beams entering the plate is thereby constantly changed slightly, and light exit uniformly distributed over the plate surface takes place at a very small angle. Light guide plates of this type are advantageously illuminated from one edge, so that uniform light emission over the plate surfaces is obtained due to light refraction.

In order to achieve uniform luminance, light can be shone in at a plurality of edges of the illumination unit.

Total internal reflection of the incident light can also be prevented by matching the shape of the cavities to the refractive index of the material of the multilayer film.

Finally, the present invention relates to the use of the multilayer film according to the invention. Owing to the two-dimensional and optionally flexible design, the multilayer film can be used for the production of display panels, computers, watches or flat-panel screens.

A further use of the multilayer film is the production of window panes, covers, greenhouse roofs, packaging, textiles, spectacles, headlamp covers, windscreens, signals or sun-protection devices.

1. A multilayer film having electrically switchable optical properties, containing a suspension of electrophoretically mobile particles located between two electrodes, wherein the suspension exhibits a negative electrorheological effect.

2. A multilayer film as claimed in claim 1, wherein the suspension contains a substance which exhibits the negative electrorheological effect dissolved in the suspension liquid.

3. A multilayer film as claimed in claim 2, wherein the substance having a negative electrorheological effect dissolved in the suspension liquid is a polycondensate made from phenyl isocyanate and polytetramethylene glycol or p-chlorophenyl isocyanate and polytetramethylene glycol or polymethyl methacrylate hydrated as alkali metal salt or as a blend with polystyrene-block-(polyethylene-co-propylene).

4. A multilayer film as claimed in claim 1, wherein the electrophoretically mobile particles exhibit the negative electrorheological effect.

5. A multilayer film as claimed in one of claims 1 to 4, wherein the suspension contains a plurality of particle types, where at least one particle type exhibits the negative electrorheological effect.

6. A multilayer film as claimed in claim 4 or 5, wherein the electrophoretically mobile particles are coated with polycondensates made from phenyl isocyanate and polytetramethylene glycol or p-chlorophenyl isocyanate and polytetramethylene glycol or polymethyl methacrylate hydrated as alkali metal salt or as a blend with polystyrene-block-(polyethylene-co-propylene).

7. A multilayer film as claimed in claim 5, wherein electrophoretically immobile particles exhibit the negative electrorheological effect.

8. A multilayer film as claimed in claim 7, wherein the electrophoretically immobile particles consist of phenyl isocyanate and polytetramethylene glycol or p-chlorophenyl isocyanate and polytetramethylene glycol or polymethyl methacrylate hydrated as alkali metal salt or as a blend with polystyrene-block-(polyethylene-co-propylene).

9. A multilayer film as claimed in one of claims 1 to 8, wherein the suspension is contained in compartments having a monomodal, unimodal, bimodal or multimodal size distribution.

10. A multilayer film as claimed in one of claims 1 to 9, wherein the suspension is contained in regularly or stochastically arranged compartments having a unimodal size distribution.

11. A multilayer film as claimed in one of claims 1 to 9, wherein the suspension is contained in regularly or stochastically arranged compartments having a bimodal size distribution.

12. A multilayer film as claimed in one of claims 1 to 9, wherein the suspension is contained in regularly or stochastically arranged compartments having a multimodal size distribution.

13. A multilayer film as claimed in one of claims 1 to 12, wherein the compartments have a larger visible surface than base surface.

14. A multilayer film as claimed in one of claims 1 to 13, wherein the electrically switchable properties are at least two different optical transparencies.

15. A multilayer film as claimed in one of claims 1 to 14, wherein the electrophoretically mobile particles contain inorganic or organic pigments.

16. A multilayer film as claimed in claim 15, wherein the inorganic or organic pigments contain TiO₂, Al₂O₃, ZrO₂, FeO, Fe₂O₃, carbon black, fluorescent pigments, phthalocyanines, porphyrins or azo dyes.

17. A multilayer film as claimed in one of claims 1 to 16, wherein the electrophoretically mobile particles are coated with polyacrylates, polymethacrylates, polyurethanes or polyamides.

18. The use of a multilayer film as claimed in one of claims 1 to 17 for the production of flat-panel screens, watches, display panels or computers.

19. The use of a multilayer film as claimed in one of claims 1 to 17 for the production of window panes, covers, greenhouse roofs, packaging, textiles, spectacles, headlamp covers, windscreens, signals or sun-protection devices.
